(19) United States
(12) Patent Application Publication
(10) Pub. No.: US 2014/0202393 A1
(43) Pub. Date: Jul. 24, 2014

(54) AQUATIC-PREDATOR RESISTANT NET

(71) Applicants: Kenneth Merrill Robertson, JR., Stanley, NC (US); Koji Tamura, Bainbridge Island, WA (US); Johanna Margaretha Van Wunnik, Echt (NL)

(72) Inventors: Kenneth Merrill Robertson, JR., Stanley, NC (US); Koji Tamura, Bainbridge Island, WA (US); Johanna Margaretha Van Wunnik, Echt (NL)

(73) Assignees: NOR'EASTERN TRAWL SYSTEMS, INC, BAINBRIDGE ISLAND, WA (US); DSM IP ASSETS B.V., Heerlen (NL)

(21) Appl. No.: 14/130,141

(22) PCT Filed: Jun. 28, 2012
(86) PCT No.: PCT/EP2012/062549

§ 371 Date: Mar. 27, 2014

Related U.S. Application Data
(60) Provisional application No. 61/501,964, filed on Jun. 28, 2011.

(51) Int. Cl. D02G 3/44; A01K 61/00; D04C 1/02; A01K 74/00

(52) U.S. Cl. CPC D02G 3/442; A01K 74/00; A01K 61/007; D04C 1/02
USPC 119/228; 43/7; 57/244; 87/3

(57) ABSTRACT

There is provided a net comprising a plurality of attack-resistant cords joined in a net mesh, wherein each attack-resistant cord comprises one or more hard metal wires running at least partially along its length and one or more high tenacity yarns having a tenacity of at least 1.5N/tex.

### BACKGROUND OF THE INVENTION

The present invention relates to nets that are resistant to attack by aquatic predators, preferably for use on fish farms, as well as to a method of making such nets, and a method of using such nets.

With ever diminishing natural fish stocks efficient farming of fish (also known as aquaculture) within netted ocean enclosures is of great and increasing importance. In particular, the location offish farms is becoming more varied and challenging for the industry. It is a problem associated with many locations desirable for fish farming that aquatic predators, such as sharks and seals, frequently visit the same locations. The large schools offish held within the netted enclosures are naturally an attractive food source to the predators and as a result the predators may attack the nets in an attempt to gain access. Should the predator gain access to the netted area, the fish stock will of course be damaged, but in addition, even unsuccessful predator attacks can leave large holes in the nets allowing the farmed fish to escape the enclosure.

It has been attempted to lessen the problem of predator attack by provision of an auxiliary barrier surrounding and spaced from the net containing the farmed fish. Heavy duty, metallic wire meshes and predator nets have been employed in the construction of the auxiliary barrier. However, such meshes are heavy and difficult to handle and do not always provide adequate predator resistance.

Nets showing a degree of aquatic-predator resistance are also known, examples of which include nets containing Dyneema® yarns. In “Fish Farming International”—November 2005, pg. 34 a netting made of a very strong ultra high molecular weight polyethylene (UHMWPE) fiber—Dyneema® (manufactured by DSM Dyneema, Heerlen, The Netherlands) is discussed. Such a netting helps to prevent fish from biting holes in the net, and therefore prevents fish escape.

However, improvements in the “bite resistance” of such nets are still desired, especially to prevent attacks by large aquatic predators. Naturally, any increased predator resistance characteristics in a net should be balanced with other required characteristics of a net, for example, mesh breaking strength, constructability; transportability e.g. weight and reliability; bow/bending resistance (resistance to deformation under the influence of water currents); drag/flow resistance; environmental impact, cleaning etc.

It is an object of the present invention to provide a net that shows a good resistance to attack by aquatic predators, in particular sharks.

### THE INVENTION

In accordance with the invention there is provided a net comprising a plurality of attack-resistant cords joined in a net mesh, wherein each attack-resistant cord comprises one or more hard metal wires running at least partially along its length and one or more high tenacity yarns having a tenacity of at least 1.5N/tex.

Such a net has been found to provide excellent resistance to predator attack. Without wishing to be bound by theory, it is believed that there are at least two components to predator attack on a net, the first being a tugging/tearing and/or pushing action and the second being a cutting/slicing and/or sawing action of the predator's teeth. In the net of the current invention it is the inventor's belief that the high performance filaments may counteract the tugging action while the hard metal wires may resist the biting action, the combination of these attributes providing excellent resistance to predator attack.

The metal wires of the net may be made of a variety of metals, including for example copper (alloy) and aluminium. However, the hard metal wire is most preferably steel wire. Considering the aquatic use of the wire it is most preferred that the wire is stainless steel wire, and more preferably marine grade stainless steel wire, on account of its corrosion-resistant characteristics.

The hard metal wires preferably have a substantial thickness in order to provide high levels of resistance to predator biting and in this respect preferably have a diameter of at least 0.22 mm, preferably at least 0.23 mm, more preferably at least 0.28 mm and most preferably at least 0.30 mm. In addition the hard-metal wire preferably has a maximum diameter in order to ensure that the attack-resistant cords, and hence the net, remain flexible for handling e.g. rolling for retrieval or deployment. Preferably the diameter of the wire is no more than 1 mm, preferably no more than 0.8 mm.

The one or more hard metal wires preferably comprise a hard-metal having a Moh's hardness of at least 4.5, more preferably of at least 5.5.

It is also preferable that each attack-resistant cord is provided with a plurality of hard metal wires running adjacent to one another. The number of adjacent hard metal wires is limited by the diameter of the wires balanced against desired flexibility of the net. Generally, for thicker hard metal wire fewer wires will be incorporated into the attack-resistant cord. For production purposes the hard metal-wires are conveniently included in each attack-resistant cord as multiples of 4, with preferred numbers being 4, 8, 12, 24 and 48 adjacent hard metal wires running at least partially along the attack-resistant cord length.

Preferably each attack-resistant cord comprises from 5-90 wt % hard metal wire based on the total weight of the cord, preferably from 10-85 wt %, more preferably 20-80 wt %.

Preferably the net comprises from 5-90 wt %, preferably 10-85 wt %, more preferably 20-80 wt %, hard metal wire based on total weight of the net.

Inclusion of multiple thick wires into net structures is problematic due to the very high levels of stiffness that result compared to normal net yarns, and because metal wires will tend to show stress weakening when subjected to bending. In an advantageous aspect of the invention the attack-resistant cords are comprised of a braid of the metal wire and high performance filaments. Braiding of the yarns allows the metal wire to be intimately combined within the attack-resistant cord while avoiding the wire being subjected to undesirable and difficult bending processes associated, for example, with knitting.

Braids and braiding processes are well known. Commonly a braid is formed by crossing over a number of strands diagonally so that each strand passes alternately over and under one or more of the other strands to form a coherent cord. The terms braid and braiding are synonymous with plaits and plaiting.

In a preferred embodiment the braid has an even number (preferably a multiple of 4) of strands of from 4 to 32, more preferably of from 4 to 24, more preferably 4 to 20, and most preferably the braid is a 4, 8, 12, or 16-strand braid, most preferably 4 strands.

When braiding the hard metal wires into the attack-resistant cord of the net, one or more of the strands may consist of the metal wires. Alternatively, one or more of the strands within the braid may comprise a combination of one or more hard metal wires with high performance filaments, for example a strand may comprise one or more hard metal wires twisted together with high performance filaments. It is advantageous that the strands are combinations of the wires and filaments because this ensures that no single strand is significantly stiffer for braiding than the other strands.

An alternative but also beneficial net construction shown in FIG. 2 comprises twisted cords instead of braided cords, in which two strands are twisted together to form a cord. In such a construction, one of the strands may comprise more hard metal wire than the other strand, which other strand containing more high-tenacity yarn. It is even envisaged that one strand may comprise hard metal wire and little to no high-tenacity yarn and that the other strand comprises high-tenacity yarn and little to no metal wire. However, preferably each strand is a blend of metal wire(s) and high tenacity yarn(s), most preferably such that the strands are at least roughly equivalent to each other in hard metal wire and high-tenacity yarn content.

It is preferred that the net of the invention is a knotless net. A knotless construction of the net makes it possible to include higher quantities of metal wire as well as thicker wires within the net construction as compared to a construction in which the metal wires would have to pass through knots. The ability to include more and thicker metal wire offers better predator protection.

A convenient method of constructing a braided knotless net including hard metal wires is by knotless inter-braiding of cords at their joining points. A braided knotless net construction, absent of metal wires, is commercially available as Ultra-Cross® from NET Systems, Inc. Washington, USA, and a method of making such a net is described in Japanese Patent Publication 61-27509, the contents of which is herein incorporated by reference in its entirety.

A convenient method of constructing a twisted knotless net including hard metal wires is by knotless inter-twisting of cords at their joining points. A twisted knotless net construction, absent of metal wires, is commercially available as Twisted-Cross® from NET Systems, Inc. Washington, USA. The one or more hard metal wires in the attack-resistant cords preferably run substantially the whole length of each of the attack-resistant cords. This provides integrity as well as ease of manufacture to the net. However, the metal wires may be incorporated in lengths of at least 30 cm, more preferably at least 50 cm, more preferably at least 1 m and most preferably at least 5 m.

The one more high tenacity yarns of the attack-resistant cords preferably comprise high performance filaments having a tenacity of at least 1.5N/tex or staple fibers having a tenacity of at least 1.5N/tex.

The high performance filaments or staple fibers may be made from a variety of polymers, for example, melt spun liquid crystal polymer fiber (such as the commercially available Vectran® fiber; polypropylene fibers, polyethylene fibers, and polyester fibers, polyamide fibers (such as nylon or the commercially available Kevlar®). In a preferred embodiment, the high performance filaments or staple fibers used to construct the net according to the invention are polyolefin filaments or staple fibers. In the most preferred embodiment, the filaments or staple fibers are UHMwPE (ultra high molecular weight polyethylene) filaments or staple fibers. Such filaments or staple fibers contribute to the tensile strength of the net showing excellent predator attack resistance. Furthermore, such filaments or staple fibers are lightweight meaning that the net is easy to install and handle. A still further advantage of such filaments or staple fibers is the high resistance to abrasion believed to be of special advantage in the current invention because of the abrasive presence of the metal wires in the cords.

The UHMwPE filaments or staple fibers are preferably manufactured according to a gel spinning process as described in numerous publications, including EP 0205960 A, EP 0213208 A1, U.S. Pat. No. 4,413,110, GB 2042414 A, EP 0200547 B1, EP 04721 14 B1, WO 01/73173 A1, and Advanced Fiber Spinning Technology, Ed. T. Nakajima, Woodhead Publ. Ltd (1994), ISBN 1-855-73182-7, and references cited therein.

Preferably the UHMwPE has an intrinsic viscosity (IV) of at least 5 dl/g. IV can be determined according to method PTC-179 (Hercules Inc. Rev. Apr. 29, 1982) at a temperature of 135 degrees centigrade and using decalin as a solvent for UHMwPE, with a dissolution time of 16 hours, with an anti-oxidant DBPC in an amount of 2 g/l solution, and extrapolating the viscosities at different concentrations to zero concentration.

Particularly suitable, is UHMwPE with an IV of preferably between 8 and 40 dl/g, more preferably between 10 and 30 dl/g, even more preferably between 12 and 28 dl/g.

Preferably, the tensile strength of the UHMwPE filament or staple fiber is at least 1.5 GPa, more preferably at least 2.5 GPa. Tensile strength, is determined on multi-fiber UHMWPE yarns as specified in ASTM D885M, using a nominal gauge length of the filament or staple fiber of 500 mm, a crosshead speed of 50 percent/min and Instron 2714 clamps, type Fiber Grip D5618C.

Preferably the weight per unit length of the UHMwPE fiber is between 800 and 2400 denier, more preferably between 1200 and 1800 denier.

According to a preferred embodiment of the invention the attack-resistant cords have a thickness of from 1-10 mm, preferably 2-7 mm, more preferably from 2-5 mm between the joined points, commonly known as the legs of a net mesh.

It is preferred that substantially all cords of the net mesh of the invention are attack-resistant cords as discussed above. However, it is envisaged that a net may be constructed with a net mesh comprising a combination of both attack-resistant cords as discussed and either one or both of non-metal and non-high performance yarn containing cords.

The mesh type of the net according to the invention may be square, hexagonal, diamond and the like. Preferably, the mesh type is square, such a mesh construction giving the maximum water flow through the net and furthermore because of its continuous straight line of meshes the square mesh has extra strength.

The mesh size of the net according to the invention is preferably chosen so as to maximize the water flow through the net. This ensures good oxygenation of the water in the enclosure, which is essential to growth and survival.

Optionally, the cords of the net may be coated or impregnated with additional components such as lubricant to further reduce abrasion and inner friction, with biocides to reduce bio-fouling growth on the net, with U.V. resistant materials, and/or with physical barrier coatings. A preferred coating is a polyurethane coating.

The nets of the current invention are useful as fishing nets for enclosing fish stock on a fish farm. Because of their improved attack resistance properties, said nets can help to reduce or even eliminate the need for auxiliary barriers on fish farms.

The nets of the current invention may be useful for applications were strength, weight and attack resistance are advantageous. Examples for such applications include but are not limited to coastal protection nets, geotextile nets, fencing of animal farming installations on shore and off shore as well as anti-thievery nets for goods. Because of their improved attack resistance properties, said nets can help to protect humans, animals or goods from predator attacks on land and at sea.

The terms used in reference to the present invention have the generally accepted meanings in the technical field unless specifically defined. The following terms are defined as set forth unless alternatively defined elsewhere.

‘Yarn’ is a continuous thread of spun staple fibers or filaments.

‘Filament’ is a single, very fine, thread-like continuous fiber.

‘Staple Fiber’ is a non-continuous fiber having a length that allows them to be blended with other fibers by spinning. Staple fibers typically have lengths corresponding to the staple of cotton or wool. Preferably the staple fibers of the present invention have a length of up to about 1000 mm, more preferably of at least about 30 mm, more preferably of about 30 mm to 250 mm, more preferably from about 30 mm to about 130 mm, more preferably a length of from about 35 mm to about 100 mm, and most preferably from about 35 mm to about 70 mm.

‘Wire’ as used herein refers to a single, usually cylindrical (although possibly also elliptical or polygonal in cross-section), thin, flexible rod of metal.

“High Tenacity” in relation to the high tenacity yarn refers to a tenacity of at least 1.5, preferably at least 2.0, more preferably at least 2.5 or even at least 3.0 N/tex. There is no reason for an upper limit of the tenacity, but current technology typically offers at most a tenacity of about 5 to 6 N/tex. Tenacity can be determined by known methods, such as ASTM D2256-97.

“High Performance” in relation to the staple fibers and filaments refers to a tenacity of at least 1.5, preferably at least 2.0, more preferably at least 2.5 or even at least 3.0 N/tex. There is no reason for an upper limit of the tenacity, but available filament and staple fibers typically have at most a tenacity of about 5 to 6 N/tex. Preferably the high performance filaments and staple fibers also have a high tensile modulus, e.g. at least 50 N/tex, preferably at least 75, 100 or even at least 125 N/tex.

### DESCRIPTION OF THE DRAWINGS

The following drawing is provided for non-limiting reference only.

FIG. 1 is a schematic view of a joint portion of an example braided knotless net. As shown in FIG. 1, two cords 1 are provided. Each of the cords is braided from four strands 2. The cords are joined together at joint 3 by inter-braiding in a knotless manner. The joined cords form the basic unit of a net mesh.

FIG. 2 is a schematic view of a portion of a twisted knotless net construction. As shown in FIG. 2, cords 1 are provided. Each of the cords is twisted from two strands 2. The cords are joined together at joints 3 by inter-twisting in a knotless manner.

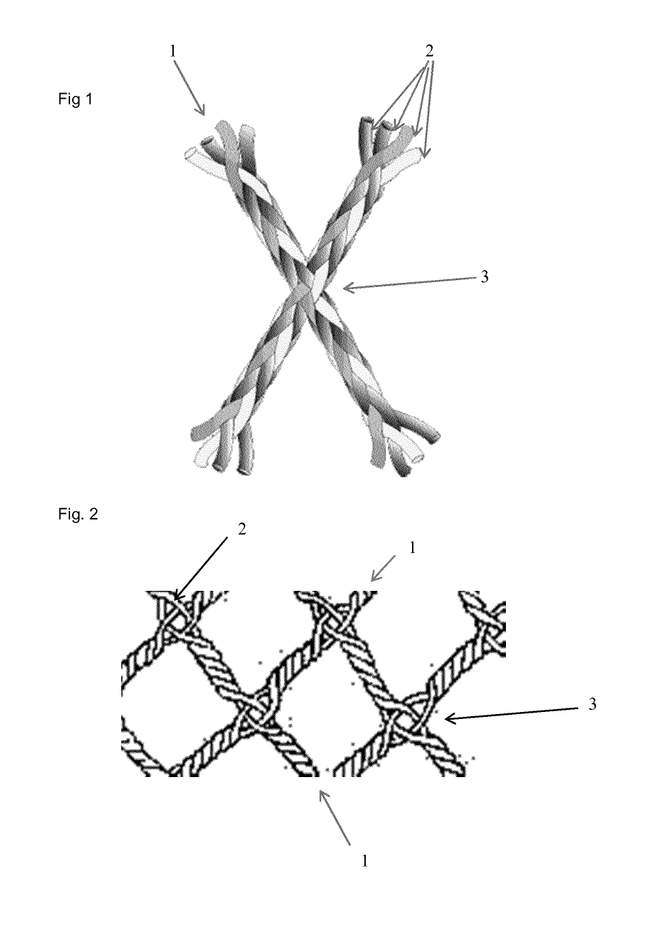

### EXAMPLES

The following examples are given by way of non-limiting reference only.

A number of net meshes were constructed according to the Ultra-Cross® braiding technique from NET Systems, Inc. The cords of the nets were constructed from Dyneema(r) yarn and continuous stainless steel wire as defined in the below table. All of the examples showed good mesh breaking strength and good resistance to razor slicing as given in the table.

| | | | ¹Mesh Break | ²F max |
|---|---|---|---|---|
| Example | | | Strength | ASTM |
| No. | Dyneema ® | Stainless Steel Wire | F max (N) | Blade (N) |
| 1 | 12 ply (2*SK75 1760) | 1 wire 0.0126″ (0.3 mm) diameter | ±3000 | 230-240 |
| 2 | 12 ply (2*SK75 1760) | 8 wires of 0.0126″ (0.3 mm) diameter | 3309 | 230 |
| 3 | 12 ply (2*SK75 1760) | 24 wires of 0.008″ (0.2 mm) diameter | 3373 | 173 |
| 4 | 8 ply (2*SK75 1760) | 12 wires of 0.009″ (0.23 mm) | 2206 | 120 |
| | | diameter | | |
| 5 | 8 ply (2*SK75 1760) | 8 wires of 0.010″ (0.25 mm) diameter | 2151 | 130 |
| 6 | 8 ply (2*SK75 1760) | 8 wires of 0.011″ (0.28 mm) diameter | 2230 | 147 |

¹Measured according to ISO1806 performed under dry conditions
²Measured by cutting a mesh leg of the example net with an ASTM blade (blade as used in ASTM F1790-97). The meshleg is horizontally strung between two opposed hooks and tied off with hand applied tensioning. The ASTM blade is drawn vertically upward across the meshleg at an angle of 30° (measured as the angle of the blade edge to the blades direction of motion), at speed of 500 mm/min. F max is the max force applied to move the blade vertically upward that does not result in full cut through of the meshleg.

1. A net comprising a plurality of attack-resistant cords joined in a net mesh, wherein each attack-resistant cord comprises one or more hard metal wires running at least partially along its length and one or more high tenacity yarns having a tenacity of at least 1.5N/tex.

2. A net according to claim 1 wherein the hard metal wire is steel wire, preferably stainless steel wire, more preferably marine grade stainless steel wire.

3. A net according to claim 1 wherein the attack-resistant cords are braids comprising one or more of the high tenacity yarns and one or more of the hard metal wires.

4. A net according to claim 1, wherein one or more metal wires is incorporated into the high tenacity yarn.

5. A net according to claim 1 wherein one or more high tenacity yarns comprise one or more high performance polymer filaments having a tenacity of at least 1.5N/tex.

6. A net according to claim 1 wherein the net is a knotless net.

7. A net according to claim 1 wherein the attack-resistant cords are joined in the net mesh by knotless inter-braiding.

8. A net according to claim 1 wherein 4, 8, 12, 24, or 48 hard metal wires run at least partially along the length of each attack-resistant cord.

9. A net according to claim 1 wherein the hard metal wires have a diameter of at least 0.22 mm, preferably at least 0.23 mm, more preferably at least 0.28 mm and most preferably at least 0.30 mm.

10. A net according to claim 1 wherein the one or more high tenacity yarns comprises high molecular weight polyolefin filaments and/or staple fibers.

11. A net according to claim 1 wherein the hard-metal of the hard-metal wire has a Moh's hardness of at least 4.5, preferably 5.5.

12. A net according to claim 1 wherein the attack-resistant cords comprise from 5-90 wt % hard metal wire, based on total weight of the attack-resistant cord, preferably from 10-85 wt %, more preferably 20-80 wt %.

13. A net according to claim 1 wherein the net comprises from 5-90 wt %, preferably 10-85 wt %, more preferably 20-80 wt %, hard metal wire based on total weight of the net.

14. A net according to claim 1 wherein the attack-resistant cords have a thickness of from 1-10 mm, preferably 2-7 mm, more preferably from 2-5 mm as measured between the joints.

15. A fishing net comprising the net of claim 1.

16. A fish farming construction comprising a net according to claim 1 joined to a frame and at least partially enclosing a volume.

17. A fish farm comprising a fish farming construction according to claim 16.

18. A method of farming fish including the step of netting off a volume of river, lake, sea or ocean water with a net according to claim 1.

19. A method of farming fish according to claim 18 comprising the steps of:
i. netting off a volume of river, lake, sea or ocean water with a knotless net according to claim 1;
ii. introducing fish to the netted off volume;
iii. providing nutrition to the fish; and
harvesting the fish.
